(19) United States
(12) Patent Application Publication
(10) Pub. No.: US 2025/0093197 A1
(43) Pub. Date: Mar. 20, 2025

(54) VIBRATION-MONITORED LASER OPTICAL UNIT

(71) Applicant: TRUMPF Lasersystems for Semiconductor Manufacturing GmbH, Ditzingen (DE)

(72) Inventors: Stefan Piehler, Stuttgart (DE); Boris Regaard, Stuttgart (DE)

(21) Appl. No.: 18/963,576

(22) Filed: Nov. 28, 2024

Related U.S. Application Data
(63) Continuation of application No. PCT/EP2023/064128, filed on May 25, 2023.

(30) Foreign Application Priority Data
Jun. 1, 2022 (DE) 10 2022 205 579.9

(51) Int. Cl. G01H 1/00; H05G 2/00

(52) U.S. Cl. CPC G01H 1/00; H05G 2/0082

(57) ABSTRACT

A method for monitoring a laser optical unit of a laser system includes guiding a laser beam through the laser optical unit, performing a first measurement of vibrations arising in the laser optical unit, structure-borne sound arising in the laser optical unit, and/or sound arising in the laser optical unit by using a sensor, and generating an output of the first measurement, and/or an output of a change of the vibrations, of the structure-borne sound, and/or of the sound.

### CROSS REFERENCE TO RELATED APPLICATIONS

This application is a continuation of International Application No. PCT/EP2023/064128 (WO 2023/232652 A1), filed on May 25, 2023, and claims benefit to German Patent Application No. DE 10 2022 205 579.9, filed on Jun. 1, 2022. The aforementioned applications are hereby incorporated by reference herein.

### FIELD

Embodiments of the invention relate to a method for monitoring a laser optical unit of a laser system. Embodiments of the invention also relate to a laser system for carrying out such a method.

### BACKGROUND

In optical units for high-performance laser applications, defects arising during operation, such as penetration burns or increase of absorption due to soiling, are a frequently occurring cause of unplanned maintenance issues or damage to machines. Embodiments of the invention are used for early detection of slowly accumulated defects (for example, continuously increasing degree of soiling) and/or individual incidents (for example, the occurrence of penetration burns on coatings and optical units due to occurring pulse peaks or particle burn off). Machine failures can thus be avoided early.

Monitoring the operation of a laser optical unit by checking a coolant temperature is known to the applicant. If a defect occurs in the laser optical unit, it heats up, which can be detected by monitoring the coolant temperature. An increase of the coolant temperature can often only be detected with a severe time delay, however.

Furthermore, monitoring a laser optical unit by means of light source and photodiode is known to the applicant. However, such monitoring is susceptible to flashes from particles which run through the laser optical unit, but do not result in defects of the laser optical unit.

Furthermore, monitoring starting variables of the laser system, for example, to compare setpoint and actual values of the laser power, is known. However, defects are also only detected comparatively late in this case.

### SUMMARY

Embodiments of the present invention provide a method for monitoring a laser optical unit of a laser system. The method includes guiding a laser beam through the laser optical unit, performing a first measurement of vibrations arising in the laser optical unit, structure-borne sound arising in the laser optical unit, and/or sound arising in the laser optical unit by using a sensor, and generating an output of the first measurement, and/or an output of a change of the vibrations, of the structure-borne sound, and/or of the sound.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows the structure of a laser system for carrying out a method according to embodiments of the invention, wherein vibrations originating from a laser optical unit are measured;

FIG. 2a shows the amplitude of measured vibrations of the laser optical unit from FIG. 1 over time, wherein a defect of the laser optical unit increases, according to some embodiments;

FIG. 2b shows the vibrations measured for FIG. 2a after filtering at approximately 50 kHz, according to some embodiments;

FIG. 2c shows the amplitude of measured vibrations of the laser optical unit from FIG. 1 over time in optimum operation, according to some embodiments; and

FIG. 2d shows the amplitude of measured vibrations of the laser optical unit from FIG. 1 over time in normal operation after subtraction of the amplitude measured in optimum operation, according to some embodiments.

### DETAILED DESCRIPTION

Embodiments of the invention provide a method which permits rapid and reliable monitoring of a laser system in a simply designed manner. Embodiments of the invention also provide a laser system for carrying out such a method.

According to some embodiments, a method for monitoring a laser optical unit of a laser system comprising the following method steps:
C) passing a laser beam through the laser optical unit;
D) detecting the vibrations, structure-borne sound, and/or sound arising in the laser optical unit by means of a sensor;
F) generating an output based on the measured vibrations, structure-borne sound, and/or sound.

A laser-induced vibration/structure-borne sound and/or sound arises/arise at a defect. Laser power is absorbed at the defect in this case, which results in a temperature increase and therefore a thermal expansion of the laser optical unit, and structure-borne sound, sound, and/or vibrations are generated in the laser optical unit. Such a defect can arise, for example, due to ablation of material of the laser optical unit.

If a sudden temperature increase occurs, e.g., due to particle burnoff, fracture of the laser optical unit, damage to coatings of the laser optical unit by pulse peaks, plasma breakthroughs in the surrounding medium or on the laser optical unit or its coating itself, it can be that a measurable shockwave will be generated in the laser optical unit. If the laser optical unit is located in an atmosphere, a sound wave will additionally also be emitted, which is likewise detectable.

Such an event can be concluded on the basis of the time curve of the detected vibrations, the detected sound, and/or structure-borne sound, for example, the occurrence of peaks in the detected signal.

In pulsed lasers or power-modulated lasers, the modulation of the laser power results in a modulation of the absorbed power and therefore in a pulsating heat source, which in turn results in a pulsating thermal expansion and therefore in turn vibrations, structure-borne sound, and sound emission. A sound, vibration, or structure-borne sound source localized around the absorbing defect is therefore to be expected, the frequency of which corresponds to the modulation frequency of the incident laser beam (for example, the pulse repetition rate in the case of pulsed lasers or the modulation/regulation frequency in the case of power-regulated continuous lasers). An amplitude increase can therefore be measured in the relevant frequency range in the frequency spectrum of the emitted sound, structure-borne sound, and/or vibrations. The intensity and therefore the amplitude of this sound, structure-borne sound, and/or these vibrations is proportional to the mean absorbed power. The absorbed power can therefore be concluded directly on the basis of the amplitude increase.

The sensors are preferably fastened on the laser optical unit in this case.

The vibrations, structure-borne sound, and/or sound arising in the laser optical unit are preferably detected by means of at least three sensors. The at least three sensors detect sound, structure-borne sound, and/or vibrations at different times in each case in case of a defect. The position of the defect in the volume of the laser optical unit can be concluded by triangulation from time-of-flight measurements (in case of a shockwave) or phase differences (in case of a frequency-based evaluation).

Therefore, chronologically discrete defect events can be concluded in the time range by monitoring the vibrations, the structure-borne sound, and/or the sound, while the analysis of the amplitude distribution in the frequency range enables a detection of slower events, for example, an absorption increase due to accumulated soiling. Both evaluation methods are complementary here and can be applied alternatively or simultaneously.

Defects occurring in the laser optical unit can be simply identified reliably and early by the detection of the vibrations, structure-borne sound, and/or sound emitted by the laser optical unit. In other words, the method according to embodiments of the invention enables efficient monitoring of a laser optical unit, wherein little installation space is required for the monitoring.

The output, preferably optical and/or acoustic, can take place on an output unit. The output can comprise an alarm if the output exceeds predefined threshold values.

The measurement in method step D) is preferably reduced to a modulation frequency range of the laser beam, in particular to a pulse frequency of the laser beam. The restriction can be carried out by a bandpass filter. The bandpass filter can be provided in the form of hardware and/or software. The modulation frequency range of the laser beam is preferably between 10 kHz and 150 kHz, in particular between 20 kHz and 130 kHz, preferably between 30 kHz and 120 kHz.

In a preferred embodiment of the method, the method additionally comprises the following method steps:
A) passing the laser beam through the laser optical unit in the defect-free state, thus in optimum operation;
B) detecting the vibrations, structure-borne sound, and/or sound arising in the laser optical unit in optimum operation by means of the sensor and storing the detected data;
E) comparing the data stored in method step B) to the data detected in method step D) and generating an output in method step F) in case of a deviation of the data.

In this way, the vibrations generated in optimum operation, the structure-borne sound generated in optimum operation, and the sound generated in optimum operation can remain unconsidered and the unpredicted deviations can be recognized easily. In one preferred embodiment of the invention, the output is first generated when the deviation of the two measurements exceeds a predefined threshold value.

The vibrations, structure-borne sound, and/or sound arising in the laser optical unit in optimum operation are preferably detected depending on the laser power. In this way, signal variations which occur due to a deliberate increase of the laser power are calibrated out.

The measurement in method step B), in particular as in method step D), is preferably reduced to a modulation frequency range of the laser beam, in particular to a pulse frequency of the laser beam. In this way, background vibrations, background structure-borne sound, and/or background sound can be suppressed.

A MEMS vibrometer and/or a laser triangulation sensor can be used as a sensor in the method according to embodiments of the invention. Alternatively or additionally, the following sensor/the following sensors can be provided for this purpose:
a) a laser vibrometer;
b) a piezoelectric microphone, in particular having sensitivity in the acoustic and/or ultrasonic range; and/or
c) a microphone, in particular in the form of an optical microphone.

In one preferred embodiment of the invention, the method comprises the following method step:
G) generating EUV radiation by irradiating target material, in particular in the form of a tin droplet, by way of the laser beam.

Embodiments of the invention also provide a laser system, in particular for carrying out a method described here, having a laser optical unit for guiding a laser beam, wherein the laser system comprises a sensor for monitoring the laser optical unit, wherein the sensor is designed in the form of
a vibration sensor;
a structure-borne sound sensor; and/or
a sound sensor.

The laser system can comprise a target material that can be irradiated using the laser beam to generate EUV radiation.

The method features mentioned for carrying out the method described here also refer to the device (laser system) and vice versa to avoid repetitions.

Further advantages of the embodiments of the invention are evident from the description and the drawing. Similarly, the features mentioned above and the features still to be explained may each be used on their own or together in any desired combinations according to embodiments of the invention. The embodiments shown and described should not be understood as an exhaustive list, but rather as being of an exemplary character.

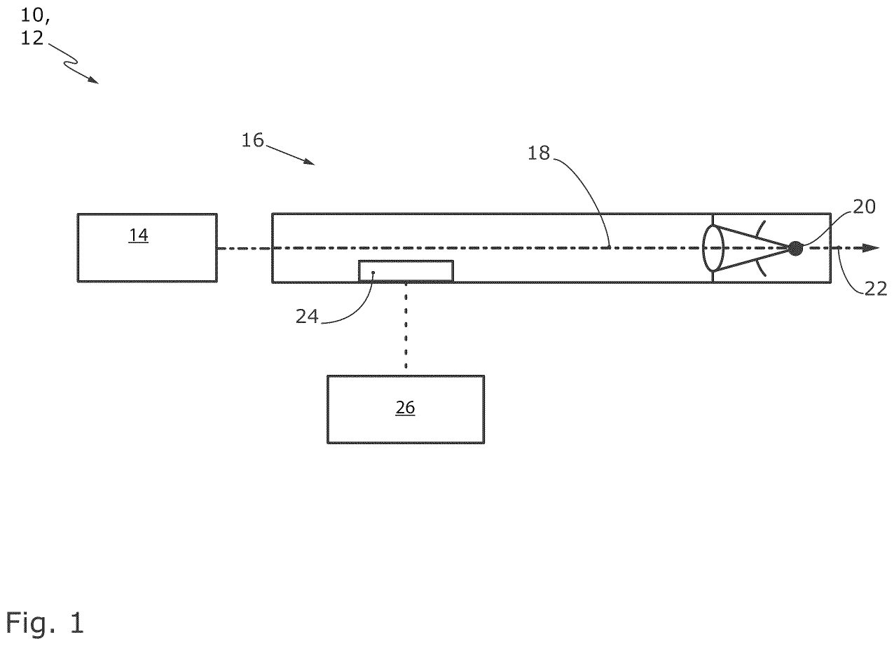

FIG. 1 shows a laser system 10 for carrying out a method 12. The laser system 10 comprises a laser source 14 and a laser optical unit 16, wherein the laser optical unit 16 can comprise one or more mirrors and/or one or more lenses. A laser beam 18 emerging from the laser optical unit 16 irradiates a target material 20, in the form of a tin droplet here. The target material 20 is excited to emit EUV radiation 22 in this way.

A sensor 24 is arranged on the laser optical unit 16, for example, on a lens or a mirror. The sensor 24 is designed to measure vibrations, structure-borne sound, and/or sound. The sensor 24 is connected in a wireless and/or wired manner to an output unit 26. The data measured using the sensor 24 are output in processed and/or unprocessed form in the output unit 26.

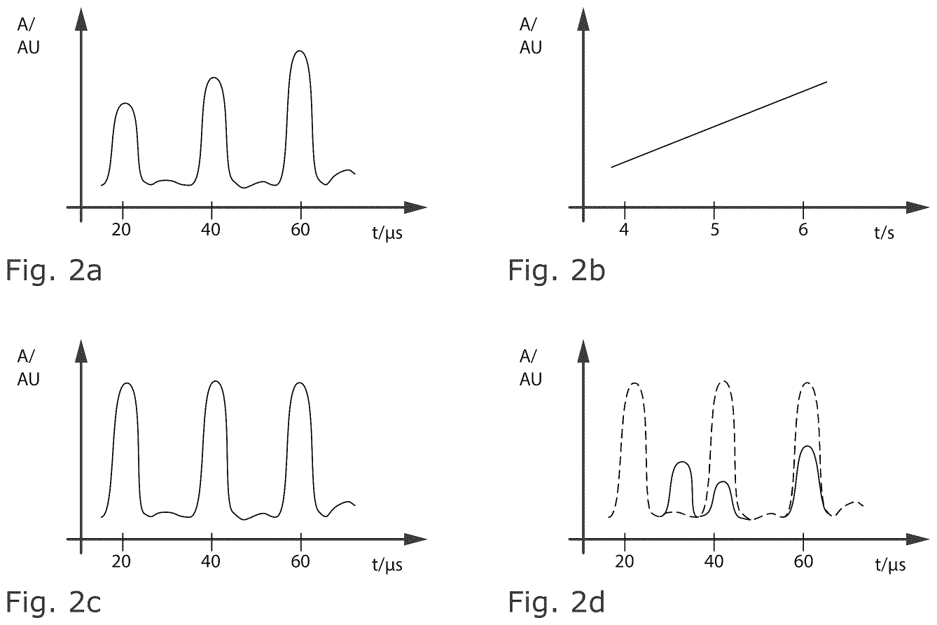

FIG. 2a shows the vibration, structure-borne sound, or sound amplitude measured using the sensor 24 in arbitrary units over time. Since the laser beam 18 is pulsed at 50 kHz, higher amplitudes are predominantly measured at an interval of 20 μs. The amplitudes increase, from which an increasing defect of the laser optical unit 16 can be concluded.

FIG. 2b shows the signal measured in FIG. 2a after passing through a bandpass filter in the range of 50 kHz. It is even more clearly apparent from FIG. 2b than from FIG. 2a that the vibrations, structure-borne sound, and/or sound to be attributed to the pulsed laser beam 18 is/are increasing.

FIG. 2c shows a measurement corresponding to FIG. 2a in optimum operation of the laser system 10. The measurement in optimum operation shown in FIG. 2c can be stored, in particular in the output unit 26.

FIG. 2d shows a measurement corresponding to FIG. 2c in normal operation after subtraction of the measurement in optimum operation. The optimum operation is represented by the dashed line. The normal operation is represented by the dashed and solid line. The actual output difference measurement (solid line) shows the signals measured in normal operation after subtraction of the signals measured in optimum operation. An additional peak results in FIG. 2d for the normal operation in comparison to the optimum operation. A suddenly occurring defect can be concluded from this additional peak, for example, a fracture of a previously damaged laser optical unit, which arises between two laser pulses. The amplitude of the peaks following this additional peak is higher than the amplitude of the peaks before this additional peak, since the laser optical unit then has a defect.

Since the sound signal is excited with the frequency and phase of the laser beam incident on the laser optical unit, a similar picture as in FIG. 2a results for a defect increasing over time, for example, for the normal operation, i.e. the amplitude of the respective peaks increases continuously. If the defect arises upon incidence of the laser beam on the laser optical unit, no additional peak results as shown in FIG. 2d. In comparison to the optimum operation, only the amplitude of the individual peaks increases. Spontaneously occurring defects can easily be detected by the concentration on the deviation from optimum operation.

As described above, embodiments of the invention relate to a method 12 for monitoring a laser optical unit 16. At least one sensor 24 measures the vibrations, structure-borne sound, and/or sound originating from the laser optical unit 16. The measurement can be restricted to a modulation frequency of a laser beam 18 conducted through the laser optical unit 16. Alternatively or additionally thereto, the measurement can be compared to a measurement in optimum operation. Embodiments of the invention also relate to a laser system 10, in particular for carrying out such a method 12.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

10 laser system
12 method
14 laser source
16 laser optical unit
18 laser beam
20 target material
22 EUV radiation
24 sensor
26 output unit

1. A method for monitoring a laser optical unit of a laser system, the method comprising:
guiding a laser beam through the laser optical unit;
performing a first measurement of vibrations arising in the laser optical unit, structure-borne sound arising in the laser optical unit, and/or sound arising in the laser optical unit by using a sensor; and
generating an output of the first measurement, and/or an output of a change of the vibrations, of the structure-borne sound, and/or of the sound.

2. The method as claimed in claim 1, wherein the first measurement of the vibrations, of the structure-borne sound, and/or of the sound is reduced to a modulation frequency range of the laser beam.

3. The method as claimed in claim 1, further comprising:
guiding the laser beam through the laser optical unit in a defect-free state;
performing a second measurement of the vibrations arising in the laser optical unit in the defect-free state, the structure-borne sound arising in the laser optical unit in the defect-free state, and/or the sound arising in the laser optical unit in the defect-free state by using the sensor, and storing the second measurement; and
comparing the second measurement to the first measurement, and generating the output of the change of the vibrations, of the structure-borne sound, and of the sound upon determining a deviation between the first measurement and the second measurement.

4. The method as claimed in claim 3, wherein the second measurement of the vibrations, of the structure-borne sound, and/or of the sound is reduced to a modulation frequency range of the laser beam.

5. The method as claimed in claim 1, wherein
the sensor comprises a laser vibrometer configured to measure the vibrations of the laser optical unit;
the sensor comprises a piezoelectric microphone having sensitivity in an acoustic range and/or an ultrasonic range arranged on the laser optical unit and configured to measure the structure-borne sound of the laser optical unit; and/or
the sensor comprises a microphone and/or an optical microphone configured to measure the sound of the laser optical unit, wherein the laser optical unit is arranged in a gas atmosphere.

6. The method as claimed in claim 1, further comprising:
generating EUV radiation by irradiating target material using the laser beam.

7. A laser system for carrying out a method as claimed in claim 1, the laser system comprising the laser optical unit for guiding the laser beam, the sensor for monitoring the laser optical unit, wherein the sensor comprises:
a vibration sensor for measuring the vibrations of the laser optical unit;
a structure-borne sound sensor for measuring the structure-borne sound of the laser optical unit; and/or
a sound sensor for measuring the sound arising from the laser optical unit.

8. The laser system as claimed in claim 7, further comprising a target material to be irradiated using the laser beam, for generating EUV radiation.
